(19) United States
(12) Patent Application Publication
(10) Pub. No.: US 2025/0095322 A1
(43) Pub. Date: Mar. 20, 2025

(54) METHOD AND ELECTRONIC DEVICE FOR IMAGE MATTING

(71) Applicant: SAMSUNG ELECTRONICS CO., LTD., Suwon-si (KR)

(72) Inventors: Chunmiao LI, Beijing (CN); Zheng Xie, Beijing (CN); Jianxing Zhang, Beijing (CN); Zikun Liu, Beijing (CN); Xiaopeng Li, Beijing (CN); Jongbum Choi, Suwon-si (KR)

(73) Assignee: SAMSUNG ELECTRONICS CO., LTD., Suwon-si (KR)

(21) Appl. No.: 18/808,629

(22) Filed: Aug. 19, 2024

Related U.S. Application Data
(63) Continuation of application No. PCT/KR2024/007554, filed on Jun. 3, 2024.

(30) Foreign Application Priority Data
Sep. 20, 2023 (CN) 202311220109.1

(51) Int. Cl. G06V 10/26; G06V 10/24; G06V 10/44; G06V 10/54; G06V 10/764; G06V 10/80; G06V 10/82

(52) U.S. Cl. CPC G06V 10/26; G06V 10/24; G06V 10/44; G06V 10/54; G06V 10/764; G06V 10/806; G06V 10/82

(57) ABSTRACT

The present disclosure provides a method performed by an electronic device, an electronic device, a storage medium and a program product, relating to the field of computer vision, image processing and artificial intelligence. The method includes: extracting at least one object center area and at least one object boundary area from a first image; and aligning the extracted object center area with the object boundary area to obtain an object segmentation result of the first image.

### CROSS REFERENCE TO RELATED APPLICATIONS

The present disclosure claims priority to International Patent Application No. PCT/KR2024/007554 filed on Jun. 3, 2024, which claims priority to Chinese Patent Application No. 202311220109.1 filed on Sep. 20, 2023, which are incorporated herein by reference in their entireties.

### TECHNICAL FIELD

Apparatuses and methods consistent with example embodiments relate to image processing, and more specifically, to image processing using fine-scale image panoptic segmentation techniques.

### BACKGROUND

With the rapid development of self-media, communication software and other fields, mobile phones have become an important tool for users to record and share their lives, which also leads users to put forward increasingly higher requirements for the functions of mobile phone cameras. Image segmentation, as the fundamental task of image processing on mobile devices, is the key support for downstream tasks.

In the related art, the image segmentation task of multiple objects cannot realize the extraction of soft boundaries, and the fine image segmentation task can only focus on one object, and cannot realize the segmentation of multiple objects at the same time. Thus, the realization of fine image segmentation for multiple objects has become a technical problem that needs to be solved urgently.

### SUMMARY

One or more embodiments of the present disclosure provides an apparatus and a method for performing image processing to realize a fine multiple-object image segmentation task.

According to an aspect of an embodiment of the present disclosure, there is provided a method performed by an electronic device, the method may include extracting at least one object center area and at least one object boundary area from a first image. The method may include matching the extracted object center area and the object boundary area to obtain an object segmentation result of the first image. The method may include aligning the extracted object center area and the object boundary area to obtain an object segmentation result of the first image.

According to an embodiment of the present disclosure, an electronic device may include a memory storing one or more instructions. The electronic device may include at least one processor configured to execute the one or more instructions to extract at least one object center area and at least one object boundary area from a first image. The electronic device may include at least one processor configured to execute the one or more instructions to align the extracted object center area with the object boundary area to obtain an object segmentation result of the first image. According to an aspect of an embodiment of the present disclosure, there is provided a computer-readable storage medium in which a computer program is stored, the computer program when executed by a processor implements the method provided by an embodiment of the present disclosure.

### BRIEF DESCRIPTION OF THE DRAWINGS

The above and/or other aspects will be more apparent by describing certain example embodiments, with reference to the accompanying drawings, in which:

FIG. 1 is a schematic flowchart of a method performed by an electronic device according to an embodiment of the present disclosure;

FIG. 2 is a schematic diagram of an object boundary area and an object center area according to an embodiment of the present disclosure;

FIG. 3 is a flow diagram of a panoptic matting method according to an embodiment of the present disclosure;

FIG. 4a is a schematic diagram of a static convolution calculation according to an embodiment of the present disclosure;

FIG. 4b is a schematic diagram of a dynamic convolution effect according to an embodiment of the present disclosure;

FIG. 4c is a schematic diagram of a dynamic convolution mechanism according to an embodiment of the present disclosure;

FIG. 4d is a schematic diagram of a dynamic convolution calculation according to an embodiment of the present disclosure;

FIG. 5 is a schematic diagram of a boundary expansion convolution according to an embodiment of the present disclosure;

FIG. 6 is a schematic diagram of a method for adding semantics to a texture according to an embodiment of the present disclosure;

FIG. 7 is a schematic diagram of a boundary feature attention module according to an embodiment of the present disclosure;

FIG. 8 is a schematic diagram of a cross attention effect according to an embodiment of the present disclosure;

FIG. 9 is a schematic diagram of a boundary and center area extraction module according to an embodiment of the present disclosure;

FIG. 10 is a schematic diagram of matching a center area and a boundary area according to an embodiment of the present disclosure;

FIG. 11 is a schematic diagram of a matting matching module according to an embodiment of the present disclosure;

FIG. 12 is a schematic diagram of a complete panoptic matting method according to an embodiment of the present disclosure; and

FIG. 13 is a schematic structure diagram of an electronic device according to an embodiment of the present disclosure.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

When a component is the to be “connected” or “coupled” to the other component, the component can be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

While such terms as “first,” “second,” etc., may be used to describe various elements, such elements must not be limited to the above terms. The above terms may be used only to distinguish one element from another.

The term “or” used in various embodiments of the present disclosure includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless defined differently, all terms used herein, which include technical terminologies or scientific terminologies, have the same meaning as that understood by those skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

At least some of the functions in the apparatus or electronic device provided in an embodiment of the present disclosure may be implemented by an artificial intelligence (AI) model. For example, at least one of a plurality of modules of the apparatus or electronic device may be implemented through the AI model. The functions associated with AI may be performed through a non-volatile memory, a volatile memory, and a processor.

The processor may include one or more processors. At this time, the one or more processors may be general-purpose processors such as a central processing unit (CPU), an application processor (AP), etc., or a pure graphics processing unit, such as a graphics processing unit (GPU), a visual processing unit (VPU), and/or an AI specialized processor, such as a neural processing unit (NPU).

The one or more processors control processing of the input data according to predetermined operating rules or AI models stored in the non-volatile memory and the volatile memory. The predetermined operation rules or AI models are provided by training or learning.

Here, “providing through learning” refers to obtain a predetermined operation rule or an AI model having desired features by applying a learning algorithm to multiple learning data. The learning may be performed in the apparatus or electronic device itself in which the AI according to the embodiments is performed, and/or may be implemented by a separate server/system.

The AI models may include a plurality of neural network layers. Each layer has a plurality of weight values. Each layer performs the neural network calculation by calculation between the input data of that layer (e.g., the calculation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e. g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided in the present disclosure may relate to one or more of technical fields such as speech, language, image, video, and data intelligence.

In the image or video field, in accordance with the present disclosure, image segmentation may be performed to obtain the output data after extraction of an object area in the image by using image data as input data of an AI model. The AI model may be obtained by training. Here, “obtained by training” means that predetermined operating rules or AI models configured to perform desired features (or purposes) are obtained by training an AI model with multiple pieces of training data by training algorithms. The method of the present disclosure may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

Post-processing based on image segmentation algorithms is the mainstream direction of image processing, and the enhancement and optimization of image segmentation algorithms is the development trend of image processing. Embodiments of the present disclosure provide an efficient image segmentation method for obtaining soft mask predictions of multiple objects in an image.

Next, the technical solution of an embodiment of the present disclosure and the technical effects produced by the technical solution of an embodiment of the present disclosure will be described by referring to an embodiment. It should be noticed that the following embodiments can be referred to, learned from or combined with each other, and the same terms, similar characteristics and similar implementation steps in different embodiments are not repeated.

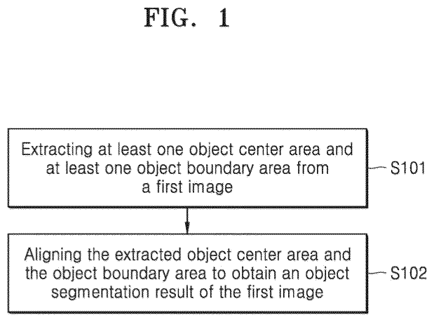

A method performed by an electronic device is provided in an embodiment of the present disclosure, as shown in FIG. 1, which includes:

Step S101: extracting at least one object center area and at least one object boundary area from a first image;

In an embodiment of the present disclosure, the first image refers to an image including the at least one object to be identified or extracted through a segmentation task. The first image may be a stored image, such as an image selected in a photo album, an image to be stored, such as an image obtained (e.g. captured, received, taken) in real time using a camera, an image downloaded from a network, or an image received from another device. Embodiments of the present disclosure do not specifically limit the source of the first image herein.

The type of the object in the first image is not specifically limited. As an example, the object to be segmented may include uncountable semantic objects (stuffs) with an irregular shape, such as a sky, a grass, etc.; and/or may include countable instance objects (things) with a certain regular shape, such as a person, a pet, etc., without being limited thereto.

In an embodiment of the present disclosure, the object in the first image is divided into an object center area (which may also be referred to as an object solid area, an object center area, or an object inner area) and an object boundary area (which may also be referred to as an object boundary area or an object edge area), and the object boundary area and the object center area of the segmented object are extracted and predicted, respectively. The object center area may represent a texture of the inner area of the object. For the object boundary area, it focuses on the boundary texture of the object, focusing on local features obtained from the boundary details; while for the object center area, it focuses on the inner area of the object, focusing on the global information extracted from the panoptic object, and not focusing on the boundary detailed information. The object boundary area may be a ring-shaped area, but not limited thereto.

Step S102: matching the extracted object center area and the object boundary area to obtain an object segmentation result of the first image. Matching the extracted object center area with the object boundary area may be understood as aligning the extracted object center area with the object boundary area.

In an embodiment of the present disclosure, the object center area and the object boundary area of the segmented object in the first image are matched to obtain a fine segmentation result for each object.

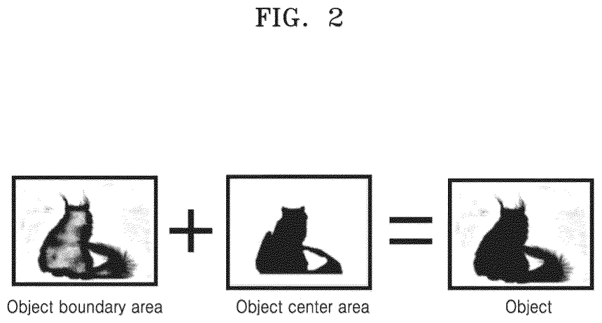

As an example, as shown in FIG. 2, a fine segmentation result including a boundary texture and an interior area of the object is obtained by performing extracting, predicting and matching on the object boundary area and the object center area respectively, while focusing on the local features obtained from the boundary details and the global information extracted from the panoptic object.

The object segmentation result of the first image, specifically, may be expressed as a mask (which may also be referred to as a segmentation mask or an object segmentation mask) prediction of each object in the first image, wherein a pixel value of a pixel at the boundary of the mask indicates a probability that the pixel point belongs to the current object.

That is, by the method provided by an embodiment of the present disclosure, it is possible to obtain a soft mask prediction of uncountable objects with an irregular shape (such as a sky, a grass, etc.) and countable instance objects with a certain regular shape (such as a person, a pet, etc.) in an image, which can give the boundary details of the objects, such as strands of hair, branches and leaves of a plant, and so on.

It is to be understood that the method provided by an embodiment of the present disclosure can be applied to a first image including only one object to realize the soft mask prediction of one object; or, it can be applied to a first image including a plurality of objects, and in the case where the first image includes an object A and an object B, for example, the soft mask prediction for each of the objects can be realized by matching a center area of the object A and a boundary area of the object A, and matching a center area of the object B and a boundary area of the object B.

The method provided by an embodiment of the present disclosure can be referred to as a panoptic matting technology, which is to perform fine segmentation of all the objects in the image, and obtain a soft boundary mask of each object in the image. The soft boundary means that the pixel value of the pixel at the edge of the mask indicates the probability that the pixel point belongs to the current object, unlike a hard boundary being presented as binary values indicating whether each pixel belongs to the object or not. The soft boundary mask may assign intermediate values along the boundary pixels, indicating a degree of uncertainty or gradual transition between different regions.

According to the method provided by an embodiment of the present disclosure, it may divide all objects in the first image into an object center area and an object boundary area, and realize the unification of global information extracted from panoptic objects and local features obtained from boundary details by extracting and predicting the object center area and the object boundary area, respectively, so as to achieve fine image segmentation of multiple objects.

In an embodiment of the present disclosure, an embodiment of implementation is provided for step S101, which may include:

Step S1011: extracting a first image feature of the first image, the first image feature including semantic information of the first image;

A shallow feature map and a deep feature map can be extracted from the input first image. The shallow feature map (also referred to as a low-level feature map) contains more detailed information about the image, such as color, boundaries, gradient, etc. The deep feature map (also referred to as a high-level feature map) contains richer semantic information contextual relationships within the image and collects detailed information about the image, such as object shapes, structures, and spatial arrangements. The deep feature map can be used in an embodiment of the present disclosure as the first image feature. The shallowness and the depth of the map may be quantified by the number of neural network layers involved in feature extraction such that more number of neural network layers may be used for the deep feature map than for the shallow feature map.

Step S1012: extracting a boundary texture feature of the first image;

In an embodiment of the present disclosure, the boundary texture feature are features related to a texture that may be a boundary in the first image. Compared with the center area of an object, the boundary area of an object not only needs to include soft edges, but also needs to give the corresponding object class, so the prediction of the boundary area is very challenging. In an embodiment of the present disclosure, the extraction of the boundary areas may be prepared by extracting and enhancing the boundary texture feature of the image in advance.

In an embodiment, the boundary texture feature may include a boundary detailed texture and semantic information for each object.

In an embodiment, the shallow feature map and the deep feature map extracted in the first image may be used to extract the boundary texture feature of the first image.

Step S1013: extracting, based on the first image feature and the boundary texture feature, at least one object center area and at least one object boundary area from the first image.

In an embodiment of the present disclosure, based on the boundary texture feature and the deep semantic feature (i.e., the first image feature), the feature representation of the object boundary area and the object center area may be predicted and converted into a boundary portion mask and a center portion mask, respectively. Wherein, the object boundary area may require the boundary texture feature to obtain both detailed information and the deep semantic feature to obtain semantic information, while the object center area may not require detailed information and may use only the deep semantic feature.

In an embodiment, the step may also establish a relationship between the object boundary area and the object center area to ensure that the associated object boundary area and the object center area are from the same object.

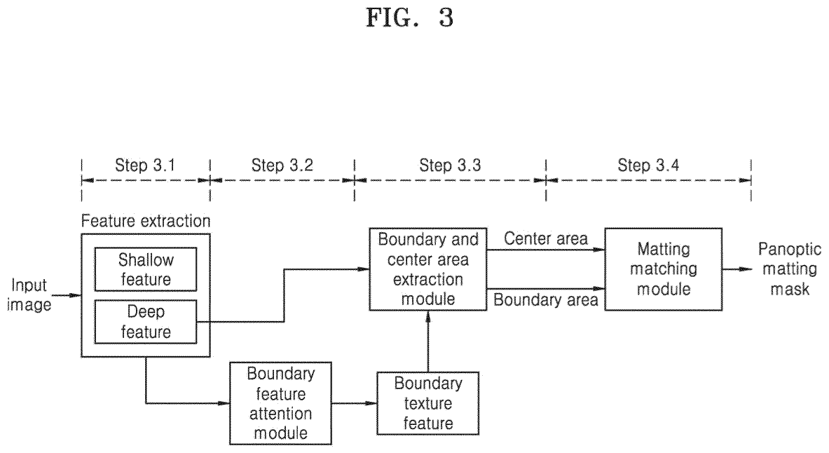

Based on at least one of the above embodiments, an example flow of a panoptic matting method, as shown in FIG. 3, may include the following steps.

Step 3.1: performing feature extraction on an input image (i.e., a first image), and extracting a shallow feature map and a deep feature map (i.e., a first image feature) therefrom. The shallow feature map may be obtained from a n-th layer of a machine learning model that is trained to extract image features, and the deep feature map may be obtained from a (n+m)-th layer of the machine learning model, wherein n and m are positive integers. The n-th layer and the (n+m)-th layer may be referred to as a shallow layer and a deep layer, respectively.

Step 3.2: processing the feature map obtained from the extraction to obtain a boundary texture feature, in order to prepare for the subsequent boundary extraction. Wherein, this step can be processed using a boundary feature attention module.

Step 3.3: predicting, based on the boundary texture feature and a deep semantic feature (i.e., a first image feature), at least one object center area and at least one object boundary area, respectively, and converting the at least one object center area and the at least one object boundary area into a boundary area mask and a center area mask, respectively. Wherein, this step may be processed using a boundary and center area extraction module (which may also be referred to as solid and boundary area extraction module). The object center area may be extracted based on the first image feature (e.g., the deep feature map) without using a texture feature of the object center area. The object boundary area may be extracted based on the first image feature (e.g., the deep feature map) and the boundary texture feature.

Step 3.4: Optimally matching and fusing the at least one object center area and at least one object boundary area to obtain the panoptic matting result (i.e., the object segmentation result of the first image). Wherein, this step may be processed using a matting matching module. Wherein, for the first image with multiple objects, since the object center area and the object boundary area may not be simply matched together, each object may be considered to obtain a global optimal solution (optimal matching result).

In an embodiment of the present disclosure, an alternative or additional implementation is provided for step S1012, which may include:

Step S10121: extracting a first texture feature of the first image, the first texture feature being used to characterize a degree of texture change in the first image;

In an embodiment of the present disclosure, the first texture feature may be a texture-sensitive image feature, which may contain the boundary texture feature information of each object, as well as a lot of texture feature information that is not related to the object boundary (including, but not limited to, the center area texture feature information, the noise texture, etc.).

Step S10122: performing, based on the first texture feature, a convolution processing on the first image to obtain a second texture feature of at least one object boundary area;

In an embodiment of the present disclosure, considering that the first texture feature will be interfered with by noise and irrelevant texture features, the step may be used to suppress non-boundary texture feature information unrelated to the object boundary and to enhance the boundary texture feature information, so as to obtain the second texture feature after the boundary texture enhancement and the non-boundary texture suppression.

Step S10123: determining, based on the second texture feature, the boundary texture feature of the first image.

In an embodiment of the present disclosure, after obtaining the second texture feature after boundary texture enhancement and non-boundary texture suppression, the boundary texture feature of the first image may be obtained by adding the semantic information of the object.

In an embodiment of the present disclosure, an alternative or additional implementation is provided for step S10121, which may include: extracting a second image feature of the first image; and performing texture gradient calculation on the second image feature to obtain a first texture feature of the first image.

In an embodiment of the present disclosure, considering that the texture detail features of the image depend more on the high-resolution feature map, the high-resolution feature map (i.e., the second image feature) may be extracted to obtain the texture-sensitive image feature. In practice, considering that the high-resolution feature map is generally a shallow semantic feature, the shallow feature map extracted from the first image may be directly used as the second image feature.

In an embodiment of the present disclosure, the texture-sensitive image feature (i.e., the first texture feature) may be extracted by calculating the gradient of the second image feature. When the image texture changes more, the gradient value is larger; conversely, when the image texture changes less, the gradient value is smaller.

In other embodiments, other ways may be used to extract the texture-sensitive image feature, and an embodiment of the present disclosure is not limited herein.

In an embodiment of the present disclosure, an alternative or additional implementation is provided for step S10122, which may include: for at least one local area of the first image, generating, based on the first texture feature of the local area and a first convolution kernel, a second convolution kernel corresponding to the local area; and performing, based on the second convolution kernel, a convolution processing on a corresponding local area.

In an embodiment of the present disclosure, considering that the first texture feature does not have boundary area specificity, e.g., the first texture feature may contain not only texture features of the boundary area, but also texture features of the non-boundary area, such as noise and irrelevant texture, the dynamic convolution may be utilized to suppress the non-boundary area texture feature and enhance the boundary area texture. Compared to static convolution, dynamic convolution is enhanced convolution.

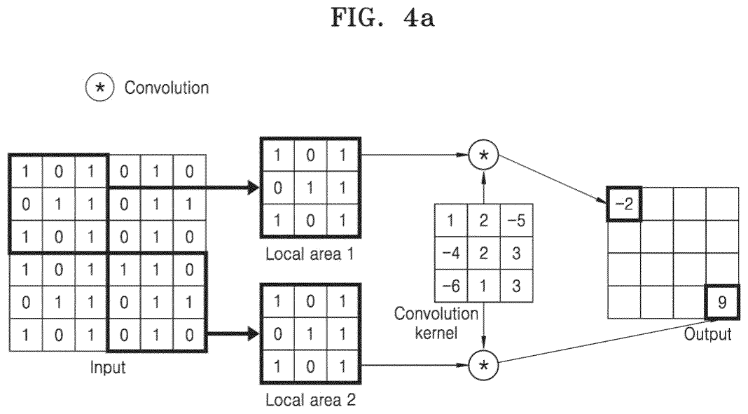

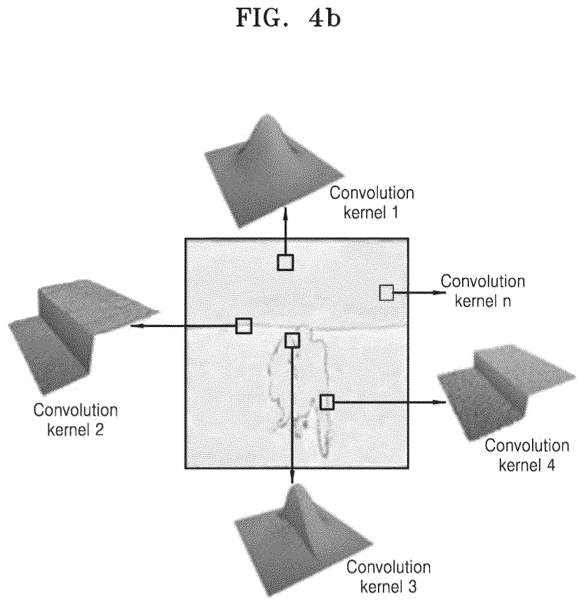

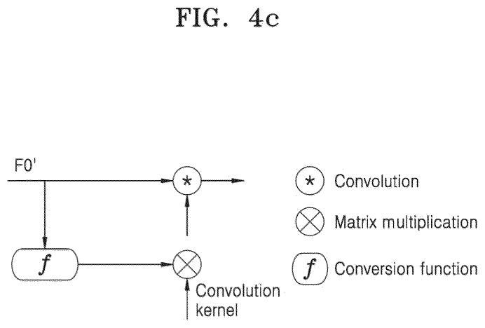

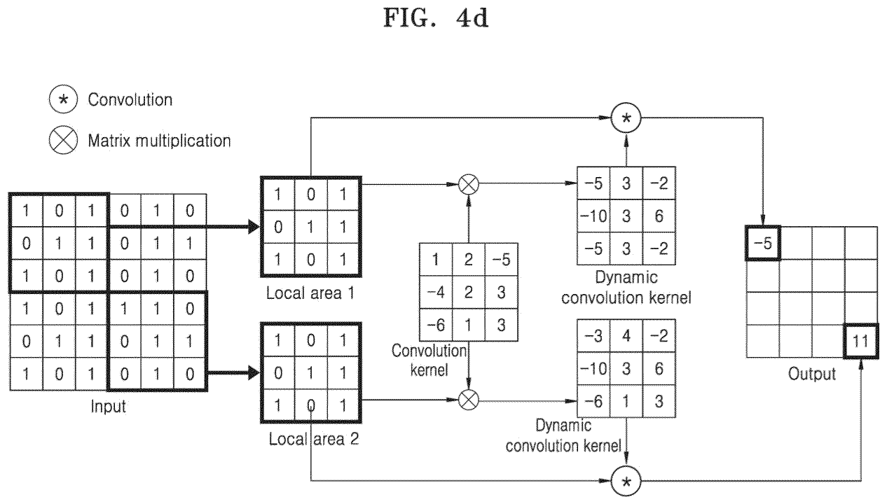

Static convolution may use the same weight of the convolution kernel in all positions of the image to complete the convolution operation, the value of the convolution kernel may not change with the change of the content of the input value, as shown in FIG. 4a (as an example of a 3*3 convolution kernel), the contents of the upper left corner and the lower right corner of the input image are different, but the same convolution kernel may be used to obtain the output result directly.

While the convolution kernel of dynamic convolution may change according to the local content of the input image or feature map, e.g., the convolution kernels used at different positions of the input feature map may be different. By imposing supervisory constraints, the dynamic convolution kernel may suppress the features in the non-boundary area and strengthen the features in the boundary area. As shown in FIG. 4b, in the non-boundary area, such as the interior of the object, the convolution kernel may be similar to a Gaussian kernel, which can suppress texture features. In the edge portion of a neighboring object, the convolution kernel may be similar to a boundary-preserving filter kernel, which is able to enhance the features in this portion. Thus, in an embodiment of the present disclosure, dynamic convolution may be performed by dividing the first image into at least one local area and performing dynamic convolution for each local area.

In an embodiment of the present disclosure, the dynamic convolution mechanism is shown in FIG. 4c, and the corresponding image block on each local area of the first texture feature F0′ is first mapped by a conversion function f. Alternatively or additionally, f may be used to perform softmax or normalization, but not limited thereto. Matrix multiplication may be performed on the mapped value with the first convolution kernel to obtain the second convolution kernel corresponding to this local area, and then convolution may be performed on the current local area with the calculated second convolution kernel to calculate the final result of the current local area.

As shown in FIG. 4d, a specific example of dynamic convolution is given for the case where the size of the first texture feature F0′ is 6×6 and the size of the dynamic convolution kernel is 3×3. In an embodiment, the contents of the upper left corner and the lower right corner of the input image are different, and the weight of the convolution kernel may be dynamically adjusted according to the texture-sensitive first texture feature, instead of using only one first convolution kernel to convolve the whole feature map. For different local areas in the first texture feature, different dynamic convolution kernels (second convolution kernels) may be calculated by performing matrix multiplication on the first convolution kernel to adaptively adjust the convolution kernel used for the current local area in conjunction with the content of the local area itself. Then the dynamic convolution kernel corresponding to each local area may be used to convolve it, the boundary area and non-boundary area may be treated differently, and the output results after boundary texture enhancement and non-boundary texture suppression may be obtained.

It should be noted that the feature maps and convolution kernels shown in FIGS. 4a and 4d are only schematic, and the specific values are subject to the actual implementation, i.e., the specific data of the feature maps and the convolution kernels do not affect the implementation of the embodiments of the present disclosure, and should not be construed as a limitation of the present disclosure.

In an embodiment of the present disclosure, an alternative or additional implementation is provided for step S10123, which may include:

Step S501: performing, based on a boundary expansion convolution kernel, a convolution processing on the second texture feature to obtain a third texture feature;

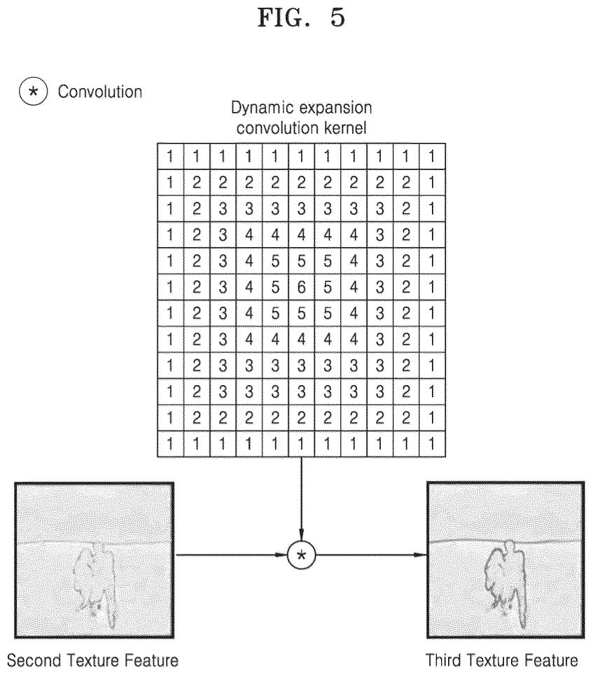

In an embodiment of the present disclosure, the texture feature (second texture feature) of the boundary area may be expanded using the boundary expansion convolution kernel. In an embodiment, as shown in FIG. 5, a convolution operation may be performed on the second texture feature using a boundary expansion convolution kernel, the boundary expansion convolution kernel has a large size, and the feature values may become larger and larger as the boundary expansion convolution kernel expands, which helps to make the predicted boundary area expand out to a certain width.

Those skilled in the art should be able to understand that the boundary expansion convolution kernel in FIG. 5 is only an example and does not constitute a limitation on the embodiment of the present disclosure, and in actual application, the person skilled in the art can set the boundary expansion convolution kernel used according to the actual situation, and the embodiment of the present disclosure are not limited herein.

Step S502: determining, based on the third texture feature, the boundary texture feature of the first image.

In an embodiment of the present disclosure, after obtaining the third texture feature after boundary expansion, and then adding the semantic information of the object, the boundary texture feature of the first image can be obtained.

In an embodiment of the present disclosure, after including the texture feature (such as the second texture feature or the third texture feature) of the boundary detailed texture, alternative or additional implementation is provided for how to incorporate the semantic information of the object in the texture feature, and, the step S502 may include:

Step S5021: extracting a third image feature of the first image, the third image feature including the semantic information of the first image;

As can be seen from the above, the deep feature map extracted from the first image contains richer semantic information of the image, so the deep feature map can be used as the third image feature.

For an embodiment of the present disclosure, the size of the third image feature may be larger than the size of the first image feature, and since the third image feature focuses more on the boundary texture and pays attention to the detailed information of the boundaries as compared to the first image feature, the third image feature may use a larger size of the deep feature map as compared to the first image feature.

Step S5022: determining a semantic feature of the first image based on the third texture feature and the third image feature using a first attention network;

In an embodiment, the semantic feature of the first image corresponding to the third texture feature may be extracted from the third image feature using the first attention network.

Alternatively or additionally, a convolution and pooling operation may be performed on the third texture feature to extract Q (Query) features from it; and a convolution and pooling operation may be performed on the third image feature F2 to extract K (Key) features and V (Value) features. The Q features are multiplied with the K features and mapped by the Sigmoid function, and the mapping result is multiplied with the V features to obtain the corresponding semantic feature in the third image feature.

Step S5023: fusing the semantic feature and the third texture feature to obtain the boundary texture feature of the first image.

Alternatively or additionally, the semantic feature obtained from the third image feature may be assigned to the boundary expansion feature map (i.e., the third texture feature) using a convolution, so as to obtain the boundary texture feature that contains not only the boundary detail feature, but also the corresponding semantic information of the object.

In an embodiment of the present disclosure, adding the corresponding semantic feature on the basis of the already obtained third texture feature can make the boundary feature correspond to the specific object.

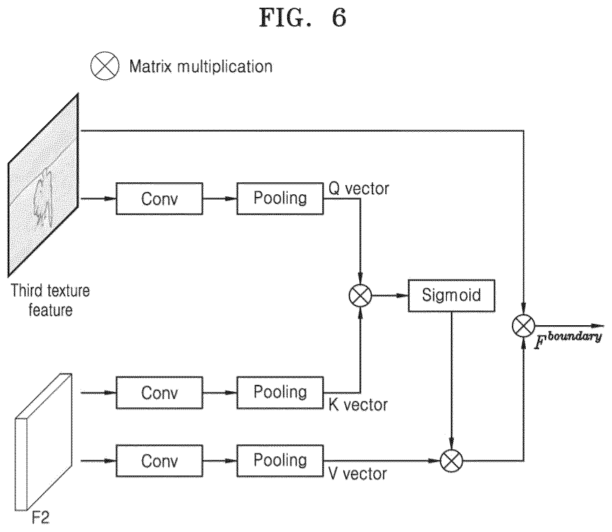

In an example, after extracting the third image feature F2 containing rich semantic information, a method of assigning the semantic information in the third image feature F2 to the third texture feature (the texture feature after boundary expansion) by utilizing an attention mechanism may be shown in FIG. 6, and may include:
Step S6.1: performing a convolution operation (Conv) and a pooling operation (Pooling) on a third texture feature to extract a Q vector;
Step S6.2: performing a convolution operation (Conv) and a pooling operation (Pooling) on the third image feature F2 to extract a K vector;
Step S6.3: applying transpose multiplication to the Q vector and the K vector and performing a Sigmoid operation to obtain an attention weight coefficient;
Step S6.4: performing a convolution operation (Conv) and a pooling operation (Pooling) on the third image feature F2 to extract a V vector;
Step S6.5: weighting the V vector according to the attention weight coefficient to output the semantic feature of the third image feature F2;
Step S6.6: multiplying the third texture feature to combine the semantic feature information to obtain the boundary texture feature F^{boundary} with both boundary texture-sensitive features and semantic information.

In an embodiment, the boundary expansion operation is an alternative or additional operation, and the semantic information of the object can be directly added to the second texture feature to obtain the boundary texture feature, i.e., step S502 may include: extracting a third image feature of the first image, the third image feature including semantic information of the first image; determining a semantic feature of the first image based on the second texture feature and the third image feature using a first attention network; fusing the semantic feature and the second texture feature to obtain the boundary texture feature of the first image. A specific processing can be found in steps S5021-step S5023, and similar processing will not be repeated herein.

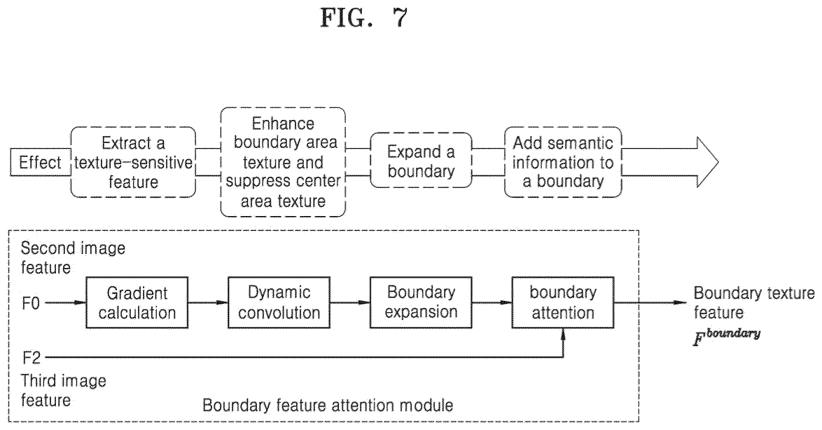

Based on at least one of the above embodiments, in one example, the image processing process of the boundary feature attention module used in step 3.2 is shown in FIG. 7, where the inputs of the module are the second image feature F0 (shallow semantic feature from the feature extractor may be used) and the third image feature F2 (deep semantic feature from the feature extractor may be used), and mainly includes the following processes:

Step S7.1: extracting a texture-sensitive image feature (i.e., first texture feature) by calculating a gradient of the second image feature F0, wherein the second image feature F0 may contain rich detailed texture information.

Step S7.2: dynamically adjusting the weight of the convolution kernel according to the first texture feature. For different local areas in the feature map, different convolution kernels may be calculated based on the image content. In a non-boundary texture-sensitive area (e.g., interior area of the object), the dynamic convolution kernel can suppress the texture, while in a boundary texture-sensitive area (e.g., object boundary area), the dynamic convolutional kernel can further strengthen the texture (e.g. enhance boundary area). As a result, the texture detail feature associated with the boundary of the object are highlighted and other features are suppressed.

Step S7.3: performing a boundary expansion convolution operation on the boundary texture-sensitive image feature (i.e., the second texture feature) that has been adjusted by the dynamic convolution to realize the widening of the texture boundary range.

Step S7.4: calculating the correlation between the boundary-expanded texture-sensitive image feature (i.e., the third texture feature) and the third image feature F2, and injecting (e.g. adding) semantic information into the third texture feature using the third image feature F2 as a query object to obtain the first texture feature F0′ as the boundary texture feature F^{boundary}, so that the final output of the boundary texture feature and the objects in the image can correspond to each other.

In an embodiment of the present disclosure, an alternative or additional implementation is provided for step S1013, which specifically may include:

Step S10131: extracting an object feature representation of the first image;

In an embodiment, the object feature representation may be used to reflect the class and spatial information of the object.

In an alternative or additional embodiment, the step may include: extracting a fourth image feature of the first image, the fourth image feature including semantic information of the first image; extracting a first query feature and a second query feature of the first image as an object feature representation in the fourth image feature by initialized query features.

Alternatively or additionally, the first query feature and the second query feature may be used to extract at least one object boundary area and at least one object center area, respectively.

The initialized query features may be a set of trained query vectors, which may for example include N queries. The initialized query features and the fourth image feature are input into a first decoder (which may also be referred to as Transformer Decoder), and the initialized query features may extract class and spatial information in the fourth image feature to obtain N intermediate queries. Alternatively or additionally, the N intermediate queries output by the first decoder may be divided into two equal parts, which are respectively output as a first query feature and a second query feature. Wherein, the N/2 intermediate queries as the first query feature may be learned to be more sensitive to the boundary information, and the N/2 intermediate queries as the second query feature are learned to be more sensitive to the center area information. In practice, the relationship between the first query feature, the second query feature and the queries can be set and trained according to the actual situation, and an embodiment of the present disclosure are not limited herein.

Step S10132: determining, based on the object feature representation, the first image feature, and the boundary texture feature, an area feature representation of the at least one object boundary area and an area feature representation of the at least one object center area, using a self-attention decoding network.

In an embodiment, using the self-attention decoding network, the object feature representation may be updated to obtain the area feature representation of the at least one object boundary area and the area feature representation of the at least one object center area, based on the first image feature and the boundary texture feature.

In an embodiment of the present disclosure, in order to obtain the area feature representation of the at least one object boundary area (which may be referred to as the boundary feature representation or the boundary embedding) and the area feature representation of the at least one object center area (which may be referred to as the center feature representation, or the solid feature representation, or the center embedding, or the solid embedding), a prediction is performed on the boundary embedding and the center embedding using the self-attention decoding network.

Since boundary information and semantic information are combined in the boundary texture feature, it may be selected to be used for extracting an area feature representation of at least one object boundary area.

In an embodiment, a first query feature (e.g., N/2 queries output by the first decoder) and a boundary texture feature F^{boundary} are jointly input into a self-attention decoding network for interactive calculation, and N/2 intermediate queries will be queried in F^{boundary} to output N/2 boundary feature representations (i.e., updated N/2 queries) with boundary information for representing at least one object boundary area.

In addition, a second query feature (e.g., another N/2 queries output by the first decoder) and a small-scale first image feature F1 are jointly input into the self-attention decoding network for interactive calculation, another N/2 intermediate queries will be queried in F1 to output N/2 center feature representation (i.e., updated another N/2 queries) with solid information for representing at least one object center area.

Wherein, since the object boundary area focuses on the boundary texture, while the object center area focuses on the inner area of the object, which does not focus on the detailed features, only a small feature map is sufficient. Therefore, the size of the first image feature F1 for extracting the center embedding may be smaller than the size of the boundary texture feature F^{boundary} (the same size as the second image feature F0 and/or the third image feature F2) for extracting the boundary embedding. Due to the small size, F1 may save network calculation resources.

Alternatively or additionally, the self-attention decoding network may employ a decoder based on the Transformer model of the self-attention mechanism, which may also be referred to as a second decoder, but is not limited thereto.

Step S10133: determining at least one object center area and at least one object boundary area based on the area feature representation of the at least one object boundary area and the area feature representation of the at least one object center area.

In an embodiment of the present disclosure, all the area feature representation (embedding) ensure that each object can obtain the corresponding boundary area and center area.

In this application embodiment, the self-attention decoding network may include at least one second attention network and at least one third attention network, and for step S10132, which may include:

Step S801: determining a first intermediate area feature representation and a first feature processing result of the at least one object boundary area based on the object feature representation and the boundary texture feature;

Alternatively or additionally, based on the first query feature (which may be understood as the Q feature of the attention mechanism) and the boundary texture feature F^{boundary}, the first intermediate area feature representation (i.e., the updated first query feature) and the first feature processing result (which may be the K feature and the V feature of F^{boundary}) may be obtained.

Step S802: determining a second intermediate area feature representation and a second feature processing result of the at least one object center area based on the object feature representation and the first image feature;

Alternatively or additionally, based on the second query feature (which may also be understood as the Q feature of the attention mechanism) and the small-scale first image feature F1, the second intermediate area feature representation (i.e., the updated second query feature) and the second feature processing result (which may be the K feature and the V feature of F1) may be obtained.

Step S803: updating the first intermediate area feature representation based on the second feature processing result to obtain an area feature representation of the at least one object boundary area, using the at least one second attention network;

For example, the second attention network updates the second query feature (Q feature) again based on the K feature and the V feature of F1.

For an embodiment of the present disclosure, this step may serve to make the boundary embedding with corresponding center area information.

In an embodiment, the second feature processing result and the first intermediate area feature representation (which can be understood as the intermediate boundary embedding) may subject to cross attention processing, i.e., establishing a semantic connection between the first query feature and the second query feature, so as to ensure that the boundary area and the center area are constrained with each other and to avoid anomalies.

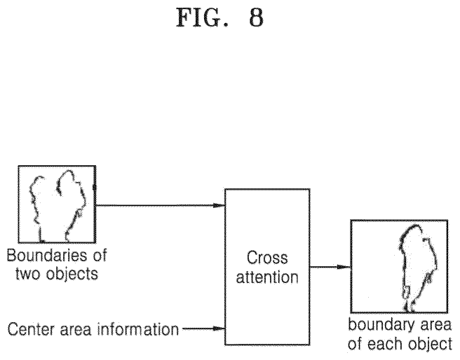

As an example, as shown in FIG. 8, two objects in the image are close together, and when extracting the boundary area, the boundaries of the two objects may be extracted as the boundary area of one object, and after establishing a semantic connection with the center area information through cross attention, the boundary area of each object can be identified.

Step S804: updating the second intermediate area feature representation based on the first feature processing result to obtain an area feature representation of the at least one object center area, using the at least one third attention network.

For example, the third attention network updates the second query feature (Q feature) again based on the K feature and the V feature of the F^{boundary}.

Similar to step S803, cross attention is also used to establish a semantic connection between the second query feature and the first query feature, and the area feature representation of the at least one object center area is extracted after interaction.

In an embodiment, the self-attention decoding network establishes a semantic connection through cross attention to ensure that the query result is available for each object.

In an embodiment, the area feature representation may include at least one of the following:
(1) class feature representation (class embedding or class prediction) that is used to represent a class represented by a boundary area or a center area;
(2) identity feature representation (identity embedding) that is used to represent respective identity information to be used for matching;
(3) mask feature representation (mask embedding or mask prediction) that is used as a dynamic convolution kernel to calculate the mask.

Alternatively or additionally, after obtaining an area feature representation of at least one object boundary area or an area feature representation of at least one object center area, the above three types of feature representations may be predicted by a multilayer perceptron (MLP) layer.

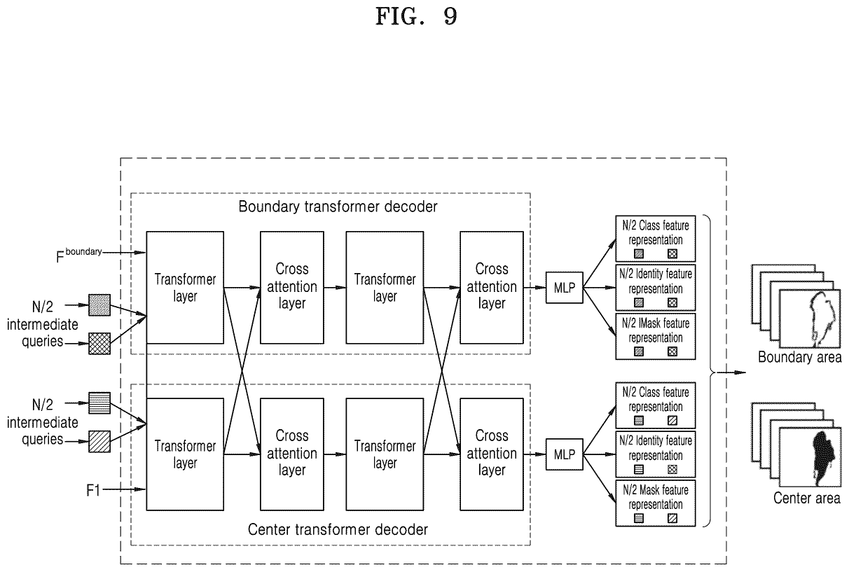

Based on at least one of the above embodiments, in one example, the processing of the boundary and center area extraction module used in step 3.3 is shown in FIG. 9, to which the module uses a boundary transformer decoder and a center transformer decoder (which may also be referred to as solid transformer decoder), respectively, to interactively and iteratively predict the input intermediate queries, as an example, which may include:

Step S9.1: dividing N intermediate queries into two equal parts and input them into a boundary transformer decoder and a center transformer decoder, respectively.

Step S9.2: in order to obtain a boundary embedding, predicting the boundary embedding using an iterative interaction way. N/2 intermediate queries (i.e., the first query feature, or Q feature of the attention mechanism) and the boundary texture feature F^{boundary} are jointly inputted into the first transformer layer for interactive calculation. N/2 boundary feature representations (embedding) (i.e., one first intermediate area feature representation, or can be understood as the updated Q feature) and the K feature and the V feature of the F^{boundary} (i.e., one first feature processing result) are output so that the output boundary feature representation (embedding) contains boundary information. Immediately after that, in order to make the boundary feature representation (embedding) with corresponding solid information, it is also necessary to perform cross attention processing on the intermediate result of the center transformer decoder (i.e., the K and V features of F1, which can also be called one second feature processing result) with the boundary feature representation (embedding) of the first branch, and use the intermediate result of the center transformer decoder to update the N/2 boundary feature representations (embedding) again. The cross-attention layer outputs the updated N/2 boundary feature representations (embedding) which are updated again (i.e., the Q feature which is updated again) and the K feature and V feature of the F^{boundary}. The final N/2 boundary feature representations (embedding) are obtained by calculating at least one set of transformer layers and cross attention layers (two sets are used as an example in FIG. 9).

Step S9.3: in order to obtain the center embedding, similar to Step S9.2, predicting the solid embedding using an interactive iteration way. N/2 intermediate queries and a small-scale first image feature F1 are input, and N/2 center feature representations (embedding) are output after interactive iteration.

Step S9.4: passing the boundary feature representation (embedding) and the center feature representation (embedding) through respective MLLPs, and the MLLPs predict three types of vectors as described above, i.e., class feature representation, identity feature representation, and mask feature representation.

An embodiment of the present disclosure may calculate the boundary feature representation (embedding) and the center feature representation (embedding) of all the objects in the image by means of feature maps of different scales to improve efficiency. All the feature representations (embedding) ensure that each object can obtain a corresponding boundary area and center area.

In an embodiment of the present disclosure, an alternative or additional implementation is provided for step S102, step S102 may include: matching the extracted object center area and the object boundary area according to at least one of the following matching methods to obtain the object segmentation result of the first image:

### (1) Direct Matching

In some scenarios, the object center area and the object boundary area may be directly aligned and/or matched. For example, when the number of objects is small, direct matching (which also referred to as “alignment”) can be performed.

### (2) Matching by Class

In an embodiment, the object center area and object boundary area with the same class can be matched.

### (3) Matching by Identity

In an embodiment, to match the center area and boundary area of objects with relevant identity information (which can also be interpreted as having relevant semantics). Identity information may include, but is not limited to, center position, shape, etc. It is also possible to match according to the center position and/or shape and other information, taking matching according to the center position as an example, i.e., through the center position of the object, the object center area and the object boundary area corresponding to the center position are matched.

In an embodiment of the present disclosure, multiple matching methods may be combined, and in one alternative or additional embodiment, step S102 may include:

Step S1021: determining a semantic correlation and a class correlation between the extracted object center area and the object boundary area;

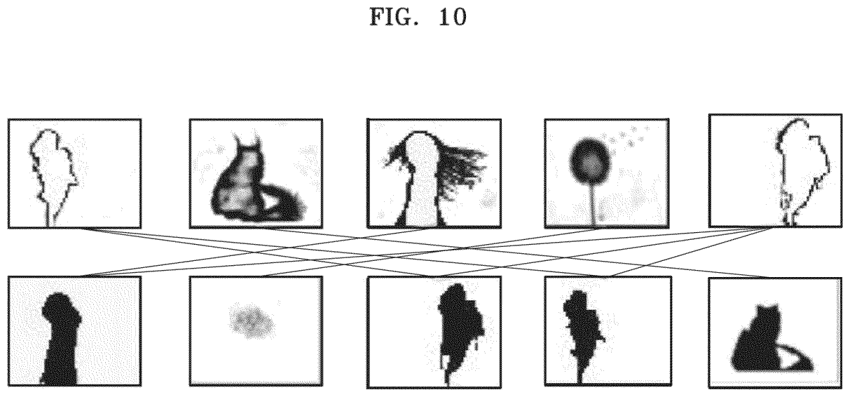

In an embodiment of the present disclosure, for each object boundary area, one or more object center area semantically related thereto can be found, and one or more object center area classically related thereto can also be found, as shown in FIG. 10. Specifically, the more the center object area and the object boundary area correspond to each other, the greater their correlation.

Step S1022: matching the object center area and the object boundary area based on the class correlation and the semantic correlation;

For a present disclosure embodiment, it is possible to avoid mis-matching caused by the fact that the object boundary area may be applicable to multi-object center area. It is also capable of avoiding mis-matching caused by the center position of the two objects being too close to each other, such as in the case of two persons standing back and forth to take a picture. It may be also able to avoid mis-matching caused by the presence of multiple objects of the same class in the picture, and also avoid mis-matching caused by sometimes inaccurate prediction of the object class.

In an embodiment, the embodiment of the present disclosure can further ensure the accuracy of matching through the semantic correlation and class correlation between the object center area and the object boundary area.

Step S1023: fusing the matched object center area and the object boundary area to obtain an object segmentation result of the first image.

Referring to FIG. 2, for the matched object center area and the object boundary area, fusing can be performed to obtain the local features obtained from the boundary details and the global information extracted from the panoptic object, and to obtain a fine segmentation result containing the boundary texture and the interior area of the object.

In an embodiment of the present disclosure, an alternative or additional implementation is provided for step S1022, which specifically may include:

Step S10221: determining the semantic correlation between the object center area and the object boundary area based on an identity feature representation of the object boundary area and an identity feature representation of the object center area;

Alternatively or additionally, based on the identity feature representation of the object boundary area and the identity feature representation of the object center area, an identity similarity matrix may be calculated, reflecting the degree of semantic connection, e.g., semantic correlation, between different object boundary areas and the object center area. Wherein, the identity feature representation is a set of vectors representing features of the object, such as position, shape, etc.

Alternatively or additionally, the identity similarity matrix is calculated by: performing matrix multiplication of the identity feature representation of the object boundary area and the identity feature representation of the object center area, generating an identity similarity matrix with a size of (N/2)*(N/2), normalizing the matrix by the operation, and outputting a final identity similarity matrix.

Step S10222: determining the class correlation between the object center area and the object boundary area based on a class feature representation of the object boundary area and a class feature representation of the object center area.

Alternatively or additionally, based on the class feature representation of the object boundary area and the class feature representation of the object center area, a class similarity matrix may be calculated, reflecting the degree of class similarity, i.e., the class correlation, between different object boundary areas and the object center area.

Alternatively or additionally, the class similarity matrix may be calculated by performing a similarity calculation of the class feature representation of the object boundary area and the class feature representation of the object center area to generate a class similarity matrix with a size of (N/2)*(N/2).

In an embodiment, step S1022 may also include: determining a matching matrix of the object center area and the object boundary area based on the class correlation and the semantic correlation, the object boundary area and the object center area in the matching matrix have a one-to-one mapping relationship;

Alternatively or additionally, the calculated identity similarity matrix and the class similarity matrix may be superimposed together, and the superimposed similarity matrices may be merged by convolution to reduce the many-to-many mapping relationship between the boundary area and the center area, and to generate a matching matrix of the object center area and the object boundary area.

In an embodiment of the present disclosure, in order to ensure that the object boundary area and the object center area in the matching matrix have a one-to-one mapping relationship, e.g., each object boundary area has a uniquely matched object center area, the correlation matrix of the object center area and the object boundary area can be determined based on the class correlation and the semantic correlation, and then the optimal matching in the correlation matrix is determined to obtain a matching matrix of the object center area and the object boundary area.

Alternatively or additionally, the calculated identity similarity matrix and the class similarity matrix may be superimposed together, and the superimposed similarity matrices may be merged and preliminarily optimized by convolution to generate a primary matching matrix (i.e., a correlation matrix), and the primary matching matrix is optimized using the Sinkhorn algorithm to determine the optimal matching in the primary matching matrix, thereby generating a final matching matrix. Wherein, the Sinkhorn algorithm is a mathematical method for solving the optimal transmission problem, and is used to obtain the optimal matching result between the boundary area and the center area in an embodiment of the present disclosure, and other algorithms may be used in other embodiments, which are not limited by an embodiment of the present disclosure herein.

In an embodiment, step S1023 may include: fusing the matched object center area and the object boundary area to obtain an object segmentation result of the first image based on a matching matrix.

In an embodiment, based on the generated matching matrix, an object center area corresponding to each object boundary area may be found, and the two parts may be superimposed and fused together, in an embodiment, by using the matching matrix to merge masks of different boundary areas and solid area, a refined segmentation result of each object in the first image can be generated.

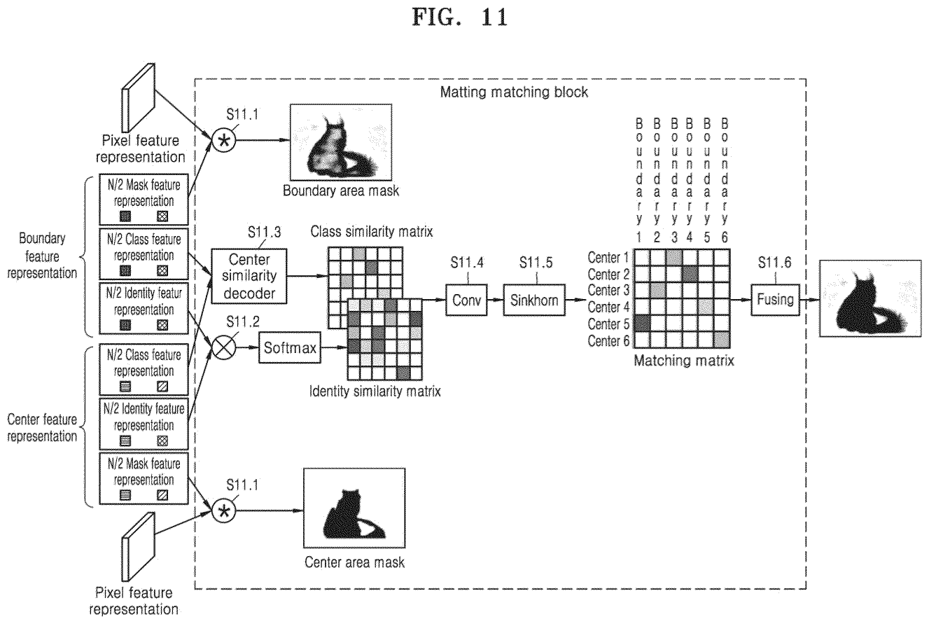

Based on at least one of the above embodiments, in one example, the processing process of the matting matching module used in step 3.4 is shown in FIG. 11, wherein the module obtains a globally optimal matching result between the boundary area and the center area by calculating a matching matrix having a one-to-one mapping relationship between the boundary area and the center area and matches the two types of areas according to the matching matrix to obtain a refined segmentation result for each object, which mainly includes:

Step S11.1: performing dynamic convolution on the image features of the coded and decoded first image (e.g., the third image feature, which can also be referred to as pixel embedding in this context) using the mask embedding output from the two branches of the boundary and center area extraction module (i.e., the boundary transformer decoder and the center transformer decoder) as a dynamic convolution kernel to generate the mask of the boundary area and the mask of the center area, respectively;

Step S11.2: in order to generate a cost matrix, performing matrix multiplication using the identity feature representation (identity embedding) corresponding to the boundary and center, respectively, output from the boundary and center area extraction module, and normalizing by operation to generate an identity similarity matrix;

Step S11.3: in order to ensure the matching accuracy, performing similarity calculation using the class feature representation (class embedding) corresponding to the boundary and center, respectively, output from the boundary and center area extraction module, to generate a class similarity matrix.

Step S11.4: superimposing the two similarity matrices of Step S11.2 and Step S11.3, and merging and initially optimizing the superimposed similarity matrices by convolution to generate a primary matching matrix (i.e., the aforementioned correlation matrix, which can also be referred to as a primary matching cost matrix);

Step S11.5: according to the primary matching matrix generated in Step S11.4, optimizing the primary matching matrix with the Sinkhorn optimization algorithm to generate the final matching matrix, at which time each element (center or boundary) to be matched has a unique matching target;

Step S11.6: according to the matching matrix generated at step S11.5, finding the center area corresponding to each boundary area, and superimposing and fusing the two parts together to generate a refined segmentation result for each defined class object of the image.

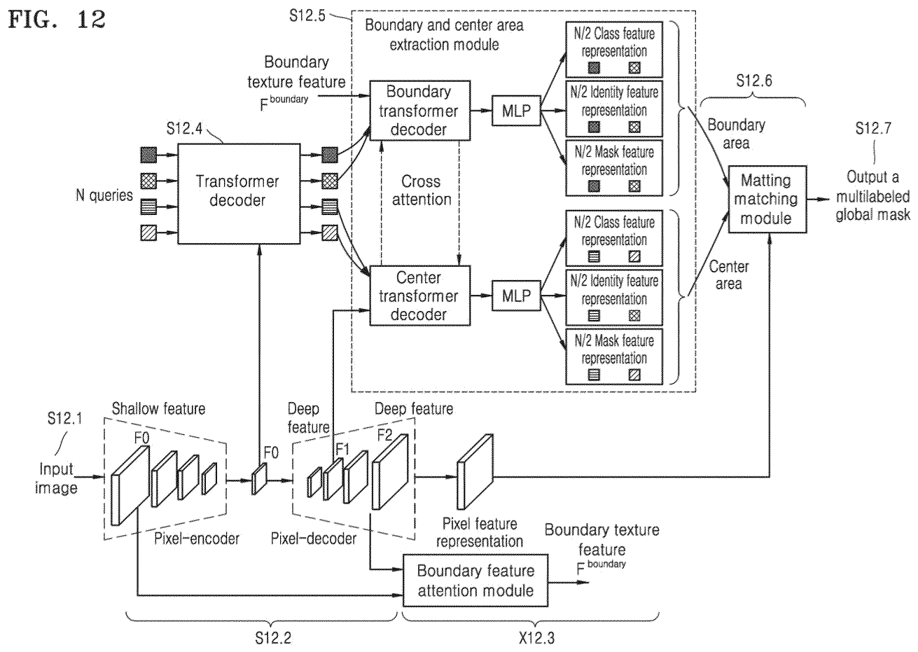

Based on at least one of the above embodiments, an example, a complete flow of a panoptic matting method is shown in FIG. 12, wherein the module may obtain a globally optimal matching result between the boundary area and the center area by calculating a matching matrix having a one-to-one mapping relationship between the boundary area and the center area, and matches the two types of areas based on the matching matrix to obtain the refined segmentation results of each object, which mainly comprises the process:

Step S12.1: inputting an image to be processed (i.e., a first image).

Step S12.2: performing feature extraction on the input image, alternatively or additionally extracting an image feature of the first image using a feature extraction network, wherein the feature extraction network includes a pixel-encoder and a pixel-decoder. Deep image features F1, F2, F3, and shallow image features F0 in the feature extraction network are obtained. Alternatively or additionally, the feature extracted using a first predetermined feature extraction layer of the decoder is used as a first image feature (i.e., F1); the feature extracted using a second predetermined feature extraction layer of the encoder is used as a second image feature (i.e., F0); the feature outputted by the decoder is used as a third image feature (i.e., F2, which may be used as a pixel embedding); and the feature outputted by the encoder is used as a fourth image feature (i.e., F3). F0 may contain detailed information, F3 may contain sufficient semantic information, and F1 and F2 may contain more semantic information.

Step S12.3: obtaining a boundary texture feature F^{boundary} using the image features F2 and F0 with the help of boundary feature attention module. The prediction of the boundary area may be more challenging compared to the center area because compared to the object center area, the object boundary area not only needs to include soft boundaries, but also needs to give the corresponding object class. Wherein, the boundary feature attention module aims to extract and enhance the boundary texture feature of the target object in the image, and to extract the boundary texture feature of the boundary area in advance to prepare for the extraction of the object boundary area. The boundary texture feature may include the boundary detailed texture and the semantic information of each object. Detailed features rely more on high-resolution feature maps (i.e., F0), and high-resolution feature maps with detailed features may be considered as shallow image features, which may appear in the first few layers of the feature extraction network, and may be interfered with by noise and irrelevant texture features. The boundary feature attention module may dynamically adjust the weight of the convolution kernel according to the boundary texture-sensitive features to suppress the noise and the internal texture (i.e., non-boundary texture-sensitive areas), enhance the boundary texture (i.e., boundary texture-sensitive areas), and add semantic information from the deep image features (i.e., F2) to the boundary texture feature through the edge attention, the detailed implementation can be found in the introduction above, and will not be repeated here.

Step S12.4: initializing a set of trained query vectors, i.e., N queries. The N queries and the image features output from the pixel-encoder (i.e., F3) are input into the transformer decoder, and the N queries extract the class and spatial information in the fourth image feature to obtain N intermediate queries. The N Intermediate queries output from the transformer decoder are equally divided into two parts to obtain the first query feature and the second query feature.

Step S12.5: inputting the boundary texture feature F^{boundary} and the deep semantic feature F1, as well as the two copies of the intermediate queries into the boundary and center area extraction module to extract the boundary area and the center area, respectively; the embodiment of the present disclosure divides the segmented object in the first image into the boundary area and the center area, and predicts and matches the boundary area and the center area of the segmented object, respectively to obtain a panoptic matting mask. The purpose of the boundary and center area extraction module is to predict the boundary area and the center area. Wherein, the boundary area focuses on the boundary texture, while the center area focuses on the inner area of the object, which does not focus on the detailed information of the boundary and only requires a small feature map (i.e., F1). Based on the difference between the boundary area and the center area, the boundary transformer decoder branch and the center transformer decoder branch in the boundary and center area extraction module use different scales of feature maps (i.e., F^{boundary} and F1) for the two areas to improve efficiency. At the same time, the two areas may be also semantically connected through cross attention to ensure that each object can obtain the corresponding feature representation, which may effectively obtain the boundary area and the center area of the target object and improve the prediction efficiency, and predict the class feature representation, the identity feature representation, and the mask feature representation corresponding to the boundary area and the center area, respectively, through the MLP. Detailed implementation can be found in the introduction above, and will not be repeated here.

Step S12.6: matching and fusing the boundary area and the center area by a matting matching module to output a panoptic matting mask. Due to direct matching, there may be a situation where one boundary area corresponds to multiple center areas, that is, there is a situation where the obtained boundary area and the center area cannot be matched one by one. The matting matching module is a module that matches the boundary area with the center area. The class similarity matrix and identity similarity matrix may be calculated, respectively, using the class feature representation and identity feature representation obtained by the boundary and center area extraction module, and by using the mutual constraints of the two, the many-to-many matching may be reduced, and further with the help of global optimization, a one-to-one matching matrix may be obtained. With the guidance of the matching matrix, combined with the mask feature representation obtained by the boundary and center area extraction module, the fine mask segmentation result of each object may be obtained by fusing, the detailed implementation can be seen in the introduction above, and will not be repeated here.

Step S12.7 outputting a multi-labeled global mask.

The panoptic matting method provided by an embodiment of the present disclosure is capable of giving the fine segmentation results of panoptic objects (uncountable semantic classes with unfixed shapes, such as sky and grass; and countable, instance classes with a certain shape regularity, such as a person, a pet, etc.) in an image, which has a crucial role in image post-processing. For example, whether in image editing, image keying or image enhancement, the fine segmentation of multiple objects will bring more perfect results.

As an example, the panoptic matting method according to an embodiment of the present disclosure can make the boundary of tree branches and leaves look more realistic and natural in image editing. As another example, the panoptic matting method according to an embodiment of the present disclosure in image keying can make the hair of a person look more detailed. As another example, the panoptic matting method according to an embodiment of the present disclosure can be used in image enhancement to make the image have a more naturally transitional boundary line.

As a basic support technology for image post-processing, the panoptic matting method provided by an embodiment of the present disclosure can be applied to image processing on a mobile terminal, which can realize real-time panoptic matting on the mobile terminal, and should be used in High Dynamic Range Imaging (HDR).

In an example, the panoptic matting method provided by an embodiment of the present disclosure can be applied to a photo album function of a mobile phone. Specifically, before step S101, it may also include: receiving an image segmentation trigger instruction from a user.

For example, the function is activated when the user performs personalized editing of the image, or when the user performs editing of the image and initiates automatic optimization. In actual application, those skilled in the art may set the triggering method of the image segmentation trigger instruction of the function according to actuality, and an embodiment of the present disclosure are not limited herein.

Further, according to the panoptic matting method provided by an embodiment of the present disclosure, after the object segmentation result of the first image is obtained at step S102, it may also include:

Step A1: outputting the object segmentation result of the first image, the object segmentation result including at least one type of object after segmentation in the first image, and each type of object including at least one;

When the fine image processing function is triggered, the image will be segmented by the fine panorama, and respective objects in the image are activated and given separately.

Step A2: receiving an object selection and/or object editing instruction from the user;

In an embodiment, the user can select and/or use each object as desired.

Step A3: performing corresponding processing on an object corresponding to the object selection and/or object editing instruction, in response to the object selection and/or object editing instruction.

For example, the user can drag, edit, and share any object; or the user can perform editing functions such as A1 changing sky, or the user can perform keying functions. For example, the user can key out the main target of the image in the album for emoticon packet production, etc.; or the user can perform image local (intelligent) optimization functions, and the image optimization will optimize or enhance the image quality enhancement, such as a personalized inpainting operation, for at least one segmented object based on the panoptic matting result (and can also be based on the semantic features of the different objects in the image). In actual application, those skilled in the art may set the scene of use of the function according to the actual situation, and an embodiment of the present disclosure are not limited herein.

The panoptic matting provided by an embodiment of the present disclosure may better extract the details of the target object, and the image editing based on the panoptic matting can naturally integrate the editing results of different objects. For example, in a scene with multiple objects, a user wishes to beautify each part of it in a different way, such as image redrawing. Specifically, for a scene with person, sky, and grass, one may expect a bluer sky, greener grass, a woman with smooth skin, and a man with more hair. The panoptic matting according to an embodiment of the present disclosure makes it a real-time function where all parts can be personalized and beautified at the same time, and because each part is mask-based, they can eventually be merged together without gaps for a more natural look.

In an example, the panoptic matting method according to an embodiment of the present disclosure can be applied to a photo mode of a mobile phone. In an embodiment, before step S101, it may also include: receiving a shooting trigger instruction from a user.

For example, when the user selects a photo-taking function of the mobile phone, the function may be activated. In practice, those skilled in the art may set the triggering method of the segmentation shooting trigger instruction for the function according to the actual, and an embodiment of the present disclosure are not limited herein.

Further, according to the panoptic matting method provided by an embodiment of the present disclosure, after the object segmentation result of the first image is obtained at step S102, it may also include:
Step B1: determining a target shooting parameter of a respective object in the object segmentation result of the first image;
Step B2: taking a corresponding respective second image based on the target shooting parameter of the respective object;
Step B3: fusing an object segmentation result of a corresponding object in the respective second image to obtain a third image.

As an example, a scene has an optimal exposure parameter for the sky, where Person A and Person B look dark; an optimal exposure parameter for Person A, where the sky and Person B seem to be overexposed; and an optimal exposure parameter for Person B, where the sky seems to be overexposed and Person A seems to be underexposed.

In contrast, in an embodiment of the present disclosure, efficient panoptic matting segments objects in the image, and the camera can calculate the optimal exposure parameters based on the different objects separately. The device takes multiple frames of the scene based on the parameters and fuses the objects with the optimal exposure parameters (the exposed portions) based on the fine segmentation mask to obtain an optimally exposed image. This is useful for scenes with large differences in brightness because the mask segmentation result for each object can be obtained.

It should be emphasized that the panoptic matting technology provided by an embodiment of the present disclosure is importantly different from various related segmentation technologies applied to mobile terminals.

First, the objects are different, the current application of the most widely used semantic segmentation technology, which divides the image according to the semantic class, but does not have the ability of respective segmentation of a single instance, such as when there are more than one person in the scene, it will not be able to differentiate; or, the saliency target segmentation introduced by album keying function, which focus on the single subject in the image, only one object is segmented; for the details of the keying, the introduced fine segmentation function, which focus on the foreground of the image, which is similarly only able to give an object segmentation mask, the limited segmentation scope cannot meet the user's needs for personalized image processing in different areas.

Second, the effects are different, the current mobile device terminal application segmentation technology (semantic segmentation, instance segmentation, panoptic segmentation, etc.) is mainly limited to hard boundary segmentation, which will affect the accuracy of the subsequent image optimization.

The panoptic matting according to an embodiment of the present disclosure provides a solution for fine segmentation of multiple objects, allowing the user to obtain each object with soft boundaries, which provides a guarantee for subsequent image processing. Specifically, the panoptic matting according to an embodiment of the present disclosure may have at least one of the following advantages over the prior art.
(1) The segmentation boundaries are not hard boundaries and more boundary details can be retained.
(2) Attention is paid to both global information and low-level semantic feature such as details, which can be extended to the extraction of boundary information of the panoptic information.
(3) It can well support pixel-level complex tasks, such as image redrawing and image keying, for example, it can optimize the sky, plants, and portraits at the same time, respectively.
(4) It has global considerations for multi-label segmentation.
(5) It can focus on multiple objects at the same time, and acquire masks for multiple objects at the same time.
(6) The network can be encapsulated into an integrated model, which is more efficient and convenient to use.
(7) The model execution time is short and the execution time is not affected by the number of objects in the image.

The technical solution provided by an embodiment of the present disclosure can be applied to various electronic devices, including but not limited to mobile terminals, smart terminals, and the like, such as smartphones, tablets, laptop computers smart wearable devices (e.g., watches, eyeglasses, and the like), smart speakers, in-vehicle terminals, personal digital assistants, portable multimedia players, navigational devices, and the like, but is not limited thereto. It will be appreciated by those skilled in the art that, in addition to elements used especially for mobile purposes, the constructions according to an embodiment of the present disclosure are also capable of being applied to stationary types of terminals, such as digital televisions, desktop computers, and the like.

The technical solution provided by an embodiment of the present disclosure can also be applied to an image style in a server, such as a stand-alone physical server, a server cluster or distributed system including a plurality of physical servers, and a cloud server providing basic cloud calculating services such as a cloud service, a cloud database, a cloud calculating, a cloud function, a cloud storage, a network service, a cloud communication, a middleware service, a domain name service, a security service, a Content Delivery Network (CDN), and a big data and artificial intelligence platform.

Specifically, the technical solution provided in an embodiment of the present disclosure can be applied to an image AI editing application or an AI camera on various electronic devices to realize advanced image processing based on fine multiple-object panoptic segmentation of images.

The embodiments of the present disclosure further comprise an electronic device comprising a processor and, optionally, a transceiver and/or memory coupled to the processor configured to perform the steps of the method provided in any of the optional embodiments of the present disclosure.

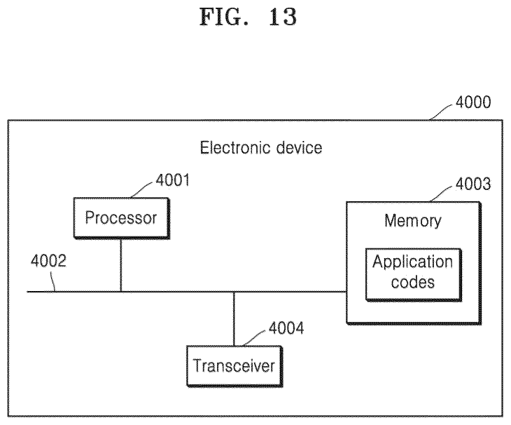

FIG. 13 shows a schematic structure diagram of an electronic device to which an embodiment of the present disclosure is applicable. As shown in FIG. 13, the electronic device 4000 in FIG. 13 includes a processor 4001 and a memory 4003. The processor 4001 may be connected to the memory 4003, for example, via a bus 4002. In an embodiment, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 may not constitute a limitation to the embodiments of the present disclosure. In an embodiment, the electronic device may be a first network node, a second network node or a third network node.

The processor 4001 may be a Central Processing Unit (CPU), a general-purpose processor, a Digital Signal Processor (DSP), an Application Specific Integrated Circuit (ASIC), a Field Programmable Gate Array (FPGA) or other programmable logic devices, transistor logic devices, hardware components, or any combination thereof. It is possible to implement or execute the various exemplary logical blocks, modules and circuits described in combination with the disclosures of the present disclosure. The processor 4001 can also be a combination that implements computing functions, such as a combination of one or more microprocessors, a combination of a DSP and a microprocessor, and the like.

The bus 4002 may include a path to transfer information between the components described above. The bus 4002 may be a Peripheral Component Interconnect (PCI) bus or an Extended Industry Standard Architecture (EISA) bus or the like. The bus 4002 can be divided into an address bus, a data bus, a control bus, and the like. For ease of representation, only one thick line is shown in FIG. 13, but it does not mean that there is only one bus or one type of bus.

The memory 4003 may be a Read Only Memory (ROM) or other types of static storage devices that can store static information and instructions, a Random Access Memory (RAM) or other types of dynamic storage devices that can store information and instructions, and can also be Electrically Erasable Programmable Read Only Memory (EEPROM), Compact Disc Read Only Memory (CD-ROM) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 4003 may be used for storing computer programs for executing the embodiments of the present disclosure, and the execution is controlled by the processor 4001. The processor 4001 may be configured to execute the computer programs stored in the memory 4003 to implement the steps shown in the foregoing method embodiments.

Embodiments of the present disclosure may provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

According to an aspect of an embodiment of the present disclosure, there is provided an electronic device comprising a memory, a processor and a computer program stored on the memory, wherein the processor executes the computer program to implement the method according to an embodiment of the present disclosure.

According to an aspect of an embodiment of the present disclosure, there is provided a computer-readable storage medium in which a computer program is stored, the computer program when executed by a processor implements the method provided by an embodiment of the present disclosure.

According to an embodiment of the present disclosure, there is provided a computer program product, comprising a computer program, wherein the computer program when executed by a processor implements the method provided by an embodiment of the present disclosure.

According to a method performed by an electronic device, an electronic device, a storage medium and a program product provided by an embodiment of the present disclosure, at least one object center area and at least one object boundary area are extracted from a first image; the extracted object center area and the object boundary area are matched to obtain an object segmentation result of the first image. That is, an object in the first image is divided into an object center area and an object boundary area, and fine image segmentation of the multiple objects is achieved by extracting and matching the object center area and the object boundary area, respectively.

The extracting the at least one object center area and the at least one object boundary area from the first image may include extracting a first image feature of the first image, wherein the first image feature comprises semantic information of the first image. The extracting the at least one object center area and the at least one object boundary area from the first image may include extracting a boundary texture feature of the first image. The extracting the at least one object center area and the at least one object boundary area from the first image may include extracting, based on the first image feature and the boundary texture feature, the at least one object center area and the at least one object boundary area from the first image.

The extracting the boundary texture feature of the first image may include extracting a first texture feature of the first image, the first texture feature being used to characterize a degree of texture change in the first image. The extracting the boundary texture feature of the first image may include performing, based on the first texture feature, a convolution processing on the first image to obtain a second texture feature of the at least one object boundary area. The extracting the boundary texture feature of the first image may include determining, based on the second texture feature, the boundary texture feature of the first image.

The performing, based on the first texture feature, the convolution processing on the first image may include, for at least one local area of the first image, generating, based on the first texture feature of the local area and a first convolution kernel, a second convolution kernel corresponding to the local area. The performing, based on the first texture feature, the convolution processing on the first image may include performing, based on the second convolution kernel, the convolution processing on a corresponding local area.

The extracting the first texture feature of the first image may include extracting a second image feature of the first image. The extracting the first texture feature of the first image may include performing texture gradient calculation on the second image feature to obtain the first texture feature of the first image. The extracting the first texture feature of the first image may include obtaining, by performing texture gradient calculation on the second image feature, the first texture feature of the first image.

The determining, based on the second texture feature, the boundary texture feature of the first image may include performing, based on a boundary expansion convolution kernel, the convolution processing on the second texture feature to obtain a third texture feature. The determining, based on the second texture feature, the boundary texture feature of the first image may include obtaining, based on a boundary expansion convolution kernel, by performing the convolution processing on the second texture feature to obtain a third texture feature. The determining, based on the second texture feature, the boundary texture feature of the first image may include determining, based on the third texture feature, the boundary texture feature of the first image.

The determining, based on the third texture feature, the boundary texture feature of the first image may include extracting a third image feature of the first image, the third image feature comprising the semantic information of the first image. The determining, based on the third texture feature, the boundary texture feature of the first image may include determining a semantic feature of the first image based on the third texture feature and the third image feature using a first attention network. The determining, based on the third texture feature, the boundary texture feature of the first image may include fusing the semantic feature and the third texture feature to obtain the boundary texture feature of the first image.

The extracting, based on the first image feature and the boundary texture feature, the at least one object center area and the at least one object boundary area from the first image may include extracting an object feature representation of the first image. The extracting, based on the first image feature and the boundary texture feature, the at least one object center area and the at least one object boundary area from the first image may include determining, an area feature representation of the at least one object boundary area and an area feature representation of the at least one object center area, based on the object feature representation, the first image feature, and the boundary texture feature, using a self-attention decoding network. The extracting, based on the first image feature and the boundary texture feature, the at least one object center area and the at least one object boundary area from the first image may include determining the at least one object center area and the at least one object boundary area based on the area feature representation of the at least one object boundary area and the area feature representation of the at least one object center area.

The extracting the object feature representation of the first image may include extracting a fourth image feature of the first image, the fourth image feature comprising the semantic information of the first image. The extracting the object feature representation of the first image may include extracting a first query feature and a second query feature of the first image as the object feature representation in the fourth image feature by initialized query features.

The self-attention decoding network may include at least one second attention network and at least one third attention network. The determining, the area feature representation of the at least one object boundary area and the area feature representation of the at least one object center area, based on the object feature representation, the first image feature, and the boundary texture feature, using the self-attention decoding network may include determining a first intermediate area feature representation and a first feature processing result of the at least one object boundary area based on the object feature representation and the boundary texture feature. The determining, the area feature representation of the at least one object boundary area and the area feature representation of the at least one object center area, based on the object feature representation, the first image feature, and the boundary texture feature, using the self-attention decoding network may include determining a second intermediate area feature representation and a second feature processing result of the at least one object center area based on the object feature representation and the first image feature. The determining, the area feature representation of the at least one object boundary area and the area feature representation of the at least one object center area, based on the object feature representation, the first image feature, and the boundary texture feature, using the self-attention decoding network may include updating the first intermediate area feature representation based on the second feature processing result to obtain the area feature representation of the at least one object boundary area, using the at least one second attention network. The determining, the area feature representation of the at least one object boundary area and the area feature representation of the at least one object center area, based on the object feature representation, the first image feature, and the boundary texture feature, using the self-attention decoding network may include updating the second intermediate area feature representation based on the first feature processing result to obtain the area feature representation of the at least one object center area, using the at least one third attention network.

The area feature representation may include at least one of a class feature representation, an identity feature representation, and a mask feature representation.

The aligning the object center area with the object boundary area to obtain the object segmentation result of the first image may include determining a semantic correlation and a class correlation between the extracted object center area and the object boundary area. The aligning the object center area with the object boundary area to obtain the object segmentation result of the first image may include aligning the object center area and with object boundary area based on the class correlation and the semantic correlation. The aligning the object center area with the object boundary area to obtain the object segmentation result of the first image may include fusing the object center area and the object boundary area to obtain an object segmentation result of the first image.

The matching the object center area with the object boundary area to obtain the object segmentation result of the first image may include determining a semantic correlation and a class correlation between the extracted object center area and the object boundary area. The matching the object center area with the object boundary area to obtain the object segmentation result of the first image may include matching the object center area and with object boundary area based on the class correlation and the semantic correlation. The matching the object center area with the object boundary area to obtain the object segmentation result of the first image may include fusing the matched object center area and the object boundary area to obtain an object segmentation result of the first image.

The aligning the object center area with the object boundary area based on the class correlation and the semantic correlation may include determining the semantic correlation between the object center area and the object boundary area based on an identity feature representation of the object boundary area and an identity feature representation of the object center area. The aligning the object center area with the object boundary area based on the class correlation and the semantic correlation may include determining the class correlation between the object center area and the object boundary area based on a class feature representation of the object boundary area and a class feature representation of the object center area.

The matching the object center area with the object boundary area based on the class correlation and the semantic correlation may include determining the semantic correlation between the object center area and the object boundary area based on an identity feature representation of the object boundary area and an identity feature representation of the object center area. The matching the object center area with the object boundary area based on the class correlation and the semantic correlation may include determining the class correlation between the object center area and the object boundary area based on a class feature representation of the object boundary area and a class feature representation of the object center area.

The aligning the object center area with the object boundary area based on the class correlation and the semantic correlation may include determining a matching matrix of the object center area and the object boundary area based on the class correlation and the semantic correlation, the object boundary area and the object center area in the matching matrix have a one-to-one mapping relationship. The fusing the matched object center area and the object boundary area to obtain the object segmentation result of the first image may include fusing the matched object center area and the object boundary area to obtain the object segmentation result of the first image based on the matching matrix. The fusing the object center area and the object boundary area to obtain the object segmentation result of the first image may include fusing the object center area and the object boundary area to obtain the object segmentation result of the first image based on the matching matrix

The determining the matching matrix of the object center area and the object boundary area based on the class correlation and the semantic correlation may include determining a correlation matrix of the object center area and the object boundary area based on the class correlation and the semantic correlation. The determining the matching matrix of the object center area and the object boundary area based on the class correlation and the semantic correlation may include determining a matching in the correlation matrix to obtain the matching matrix of the object center area and the object boundary area.

The extracting an image feature of the first image may include extracting an image feature of the first image using a feature extraction network, wherein the feature extraction network comprises an encoder and a decoder. The extracting an image feature of the first image may include obtaining a feature extracted using a first predetermined feature extraction layer of the decoder, as the first image feature. The extracting an image feature of the first image may include obtaining a feature extracted using a second predetermined feature extraction layer of the encoder, as a second image feature. The extracting an image feature of the first image may include obtaining a feature output by the decoder, as a third image feature. The extracting an image feature of the first image may include obtaining a feature output by the encoder, as a fourth image feature. The extracting an image feature of the first image may include taking a feature extracted using a first predetermined feature extraction layer of the decoder, as the first image feature. The extracting an image feature of the first image may include taking a feature extracted using a second predetermined feature extraction layer of the encoder, as a second image feature. The extracting an image feature of the first image may include taking a feature output by the decoder, as a third image feature. The extracting an image feature of the first image may include taking a feature output by the encoder, as a fourth image feature.

Before the extracting at least one object center area and the at least one object boundary area from the first image, the method may include receiving an image segmentation trigger instruction from a user. After the obtaining an object segmentation result of the first image, the method may include outputting the object segmentation result of the first image, the object segmentation result comprising at least one type of an object after segmentation in the first image. The method may include receiving either one or both of an object selection and object editing instruction from the user. The method may include performing corresponding processing on the object corresponding to either one or both of the object selection and the object editing instruction, in response to either one or both of the object selection and the object editing instruction.

Before the extracting the at least one object center area and the at least one object boundary area from the first image, the method may include receiving a shooting trigger instruction from a user. After the obtaining the object segmentation result of the first image, the method may include determining a target shooting parameter of an object in the object segmentation result of the first image. The method may include capturing a second image based on the target shooting parameter of the object. The method may include obtaining a second image based on the target shooting parameter of the object. The method may include fusing an object segmentation result of the object in the second image to obtain a third image.

According to an aspect of the present disclosure, an electronic device may include a memory storing one or more instructions, at least one processor configured to execute the one or more instructions and a computer program stored on the memory, wherein the processor executes the computer program to implement the any one of method.

According to an aspect of the present disclosure, an electronic device may include a memory storing one or more instructions; and at least one processor configured to execute the one or more instructions. The at least one processor may be configured to execute the one or more instructions to perform feature extraction on an input image to obtain an image feature. The at least one processor may be configured to execute the one or more instructions to perform boundary feature extraction on the image features to obtain a boundary texture feature of an object included in the image. The at least one processor may be configured to execute the one or more instructions to extract an object center area of the object from the input image based on the image feature without using a texture feature of the object center area. The at least one processor may be configured to execute the one or more instructions to extract an object boundary area of the object from the input image based on the image feature and the boundary texture feature. The at least one processor may be configured to execute the one or more instructions to generate an output image by aligning the object center area with the object boundary area.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method performed by an electronic device, the method comprising:
extracting at least one object center area and at least one object boundary area from a first image; and
aligning the extracted object center area with the object boundary area to obtain an object segmentation result of the first image.

2. The method according to claim 1, wherein the extracting the at least one object center area and the at least one object boundary area from the first image comprises:
extracting a first image feature of the first image, wherein the first image feature comprises semantic information of the first image;
extracting a boundary texture feature of the first image; and
extracting, based on the first image feature and the boundary texture feature, the at least one object center area and the at least one object boundary area from the first image.

3. The method according to claim 2, wherein the extracting the boundary texture feature of the first image comprises:
extracting a first texture feature of the first image, the first texture feature being used to characterize a degree of texture change in the first image;
performing, based on the first texture feature, a convolution processing on the first image to obtain a second texture feature of the at least one object boundary area; and
determining, based on the second texture feature, the boundary texture feature of the first image.

4. The method according to claim 3, wherein the performing, based on the first texture feature, the convolution processing on the first image comprises:
for at least one local area of the first image, generating, based on the first texture feature of the local area and a first convolution kernel, a second convolution kernel corresponding to the local area; and
performing, based on the second convolution kernel, the convolution processing on a corresponding local area.

5. The method according to claim 3, wherein the extracting the first texture feature of the first image comprises:
extracting a second image feature of the first image; and
obtaining, by performing texture gradient calculation on the second image feature, the first texture feature of the first image.

6. The method according to claim 3, wherein the determining, based on the second texture feature, the boundary texture feature of the first image comprises:
obtaining, by performing, based on a boundary expansion convolution kernel, the convolution processing on the second texture feature, a third texture feature; and
determining, based on the third texture feature, the boundary texture feature of the first image.

7. The method according to claim 6, wherein the determining, based on the third texture feature, the boundary texture feature of the first image comprises:
extracting a third image feature of the first image, the third image feature comprising the semantic information of the first image;
determining a semantic feature of the first image based on the third texture feature and the third image feature using a first attention network; and
fusing the semantic feature and the third texture feature to obtain the boundary texture feature of the first image.

8. The method according to claim 2, wherein the extracting, based on the first image feature and the boundary texture feature, the at least one object center area and the at least one object boundary area from the first image comprises:
extracting an object feature representation of the first image;
determining, an area feature representation of the at least one object boundary area and an area feature representation of the at least one object center area, based on the object feature representation, the first image feature, and the boundary texture feature, using a self-attention decoding network; and
determining the at least one object center area and the at least one object boundary area based on the area feature representation of the at least one object boundary area and the area feature representation of the at least one object center area.

9. The method according to claim 8, wherein the extracting the object feature representation of the first image comprises:
extracting a fourth image feature of the first image, the fourth image feature comprising the semantic information of the first image; and
extracting a first query feature and a second query feature of the first image as the object feature representation in the fourth image feature by initialized query features.

10. The method according to claim 8, wherein the self-attention decoding network comprises at least one second attention network and at least one third attention network, and the determining, the area feature representation of the at least one object boundary area and the area feature representation of the at least one object center area, based on the object feature representation, the first image feature, and the boundary texture feature, using the self-attention decoding network comprises:
determining a first intermediate area feature representation and a first feature processing result of the at least one object boundary area based on the object feature representation and the boundary texture feature;
determining a second intermediate area feature representation and a second feature processing result of the at least one object center area based on the object feature representation and the first image feature;
updating the first intermediate area feature representation based on the second feature processing result to obtain the area feature representation of the at least one object boundary area, using the at least one second attention network; and
updating the second intermediate area feature representation based on the first feature processing result to obtain the area feature representation of the at least one object center area, using the at least one third attention network.

11. The method according to claim 8, wherein the area feature representation comprises at least one of a class feature representation, an identity feature representation, and a mask feature representation.

12. The method according to claim 1, wherein the aligning the object center area with the object boundary area to obtain the object segmentation result of the first image comprises:
determining a semantic correlation and a class correlation between the extracted object center area and the object boundary area;
aligning the object center area and with object boundary area based on the class correlation and the semantic correlation; and
fusing the object center area and the object boundary area to obtain an object segmentation result of the first image.

13. The method according to claim 12, wherein the aligning the object center area with the object boundary area based on the class correlation and the semantic correlation comprises:
determining the semantic correlation between the object center area and the object boundary area based on an identity feature representation of the object boundary area and an identity feature representation of the object center area; and
determining the class correlation between the object center area and the object boundary area based on a class feature representation of the object boundary area and a class feature representation of the object center area.

14. The method according to claim 12,
wherein the aligning the object center area with the object boundary area based on the class correlation and the semantic correlation comprises:
determining a matching matrix of the object center area and the object boundary area based on the class correlation and the semantic correlation, the object boundary area and the object center area in the matching matrix have a one-to-one mapping relationship, and
wherein the fusing the object center area and the object boundary area to obtain the object segmentation result of the first image comprises:
fusing the object center area and the object boundary area to obtain the object segmentation result of the first image based on the matching matrix.

15. The method according to claim 14, wherein the determining the matching matrix of the object center area and the object boundary area based on the class correlation and the semantic correlation comprises:
determining a correlation matrix of the object center area and the object boundary area based on the class correlation and the semantic correlation; and
determining a matching in the correlation matrix to obtain the matching matrix of the object center area and the object boundary area.

16. The method according to claim 2, wherein the extracting an image feature of the first image comprises:
extracting an image feature of the first image using a feature extraction network, wherein the feature extraction network comprises an encoder and a decoder;
obtaining a feature extracted using a first predetermined feature extraction layer of the decoder, as the first image feature;
obtaining a feature extracted using a second predetermined feature extraction layer of the encoder, as a second image feature;
obtaining a feature output by the decoder, as a third image feature; and
obtaining a feature output by the encoder, as a fourth image feature.

17. The method according to claim 1,
wherein before the extracting at least one object center area and the at least one object boundary area from the first image, the method further comprises:
receiving an image segmentation trigger instruction from a user, and
wherein after the obtaining an object segmentation result of the first image, the method further comprises:
outputting the object segmentation result of the first image, the object segmentation result comprising at least one type of an object after segmentation in the first image;
receiving either one or both of an object selection and object editing instruction from the user; and
performing corresponding processing on the object corresponding to either one or both of the object selection and the object editing instruction, in response to either one or both of the object selection and the object editing instruction.

18. The method according to claim 1,
wherein before the extracting the at least one object center area and the at least one object boundary area from the first image, the method further comprises:
receiving a shooting trigger instruction from a user, and
after the obtaining the object segmentation result of the first image, the method further comprises:
determining a target shooting parameter of an object in the object segmentation result of the first image;
obtaining a second image based on the target shooting parameter of the object; and
fusing an object segmentation result of the object in the second image to obtain a third image.

19. An electronic device comprising:
a memory storing one or more instructions; and
at least one processor configured to execute the one or more instructions to:
extract at least one object center area and at least one object boundary area from a first image; and
align the extracted object center area with the object boundary area to obtain an object segmentation result of the first image.

20. A non-transitory computer-readable storage medium storing a program that is executable by at least one processor to perform an image processing method comprising:
extracting at least one object center area and at least one object boundary area from a first image; and
aligning the extracted object center area with the object boundary area to obtain an object segmentation result of the first image.
